(19) United States
(12) Patent Application Publication
(10) Pub. No.: US 2012/0039035 A1
(43) Pub. Date: Feb. 16, 2012

(54) SERVER SYSTEM AND HEAT DISSIPATION DEVICE THEREOF

(75) Inventor: CHAO-KE WEI, Tu-Cheng (TW)

(73) Assignee: HON HAI PRECISION INDUSTRY CO., LTD., Tu-Cheng (TW)

(21) Appl. No.: 12/884,220

(22) Filed: Sep. 17, 2010

(30) Foreign Application Priority Data
Aug. 10, 2010 (TW) 99126688

(51) Int. Cl. G06F 1/20; F28F 7/00

(52) U.S. Cl. 361/679.47; 165/104.34; 165/185; 361/695; 361/724

(57) ABSTRACT

An exemplary server system includes a server cabinet, multiple servers, and a heat dissipation module. The server cabinet includes a rack, a front door and a rear plate. The front door and the rear plate are hinged on front and rear sides of the rack, respectively. The servers are arranged in the server cabinet along a lateral axis of the server cabinet. The heat dissipation device includes a fan module mounted on the servers and a dissipating module arranged on the fan module. The fan module is configured for drawing airflow along an upward axis in the server cabinet.

### BACKGROUND

1. Technical Field

The present disclosure relates to heat dissipation, and more particularly to a server system and heat dissipation device used by the server system.

2. Description of Related Art

Typically, a server system has multiple standard servers stacked in a standard server cabinet. The server cabinet generally includes a top wall, an opposite bottom wall, and a left sidewall, a right sidewall, a front sidewall and a rear sidewall interconnected between the top and bottom walls. The servers are fixed between the left and right sidewalls. Each of the servers includes at least a power supply device, a motherboard, a hard disk drive, and an optical disk drive. Considerable heat is generated during operation of the servers.

Generally, a plurality of cooling fans are mounted on the rear sidewall of the server cabinet for evacuating the generated heat. During operation, the cooling fans draw cooling air from a front side of the server cabinet into the server cabinet via through holes defined in the front sidewall. The cooling air flows through the servers along a longitudinal axis of the server cabinet to exchange heat with the servers. Finally, the heated air is exhausted out of the server cabinet via through holes defined in the rear sidewall. However, intake at the front sidewall and exhaust at the rear sidewall, particularly the heated air exhausted at the rear sidewall, may adversely affect the environment around the server cabinet.

What is needed, therefore, is a server system having a heat dissipation device which can overcome the limitations described.

### BRIEF DESCRIPTION OF THE DRAWINGS

FIG. 1 is an isometric, assembled view of a server system in accordance with an embodiment of the disclosure.

FIG. 2 is an exploded view of the server system of FIG. 1.

FIG. 3 is an exploded view of a heat dissipation device of the server system shown in FIG. 2.

### DETAILED DESCRIPTION

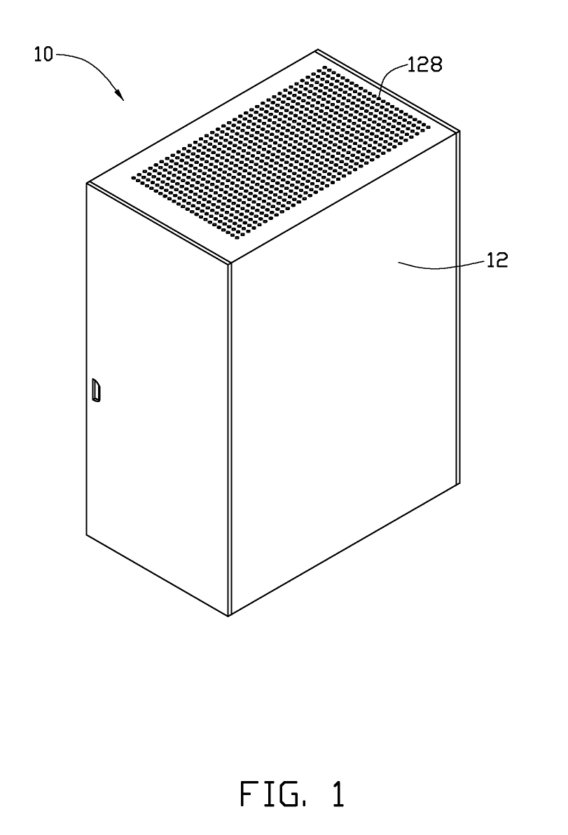

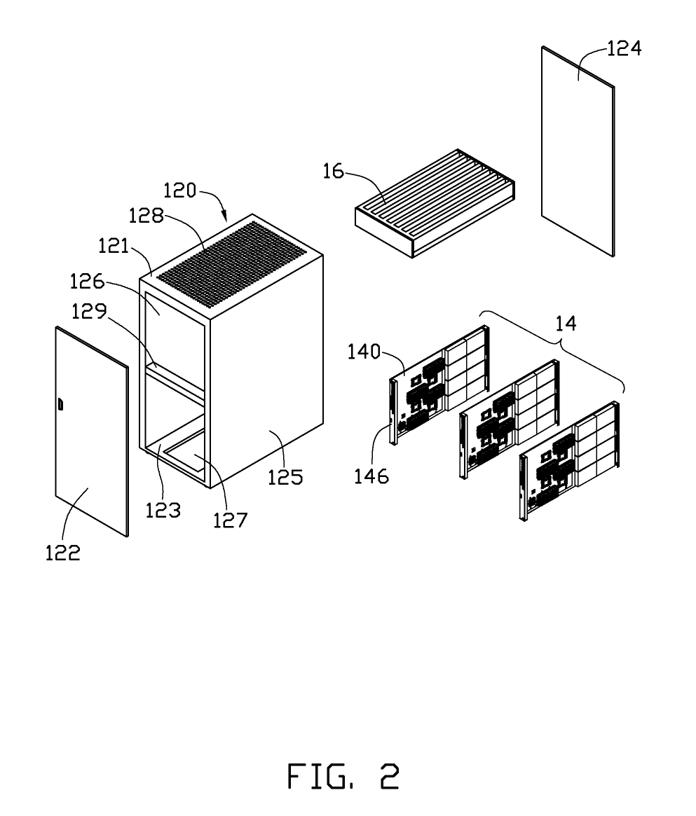

Referring to FIGS. 1 and 2, a server system 10 in accordance with an exemplary embodiment is shown. The server system 10 includes a server cabinet 12, a plurality of server units 14 accommodated in the server cabinet 12, and a plurality of heat dissipation devices 16 for cooling the server units 14. Each server unit 14 includes a plurality of servers 140 stacked together, and has one corresponding heat dissipation device 16 mounted thereon for evacuating heat therefrom. In this embodiment, for simplicity, only one server unit 14 including only three servers 140 is shown. Accordingly, only one corresponding heat dissipation device 16 is shown.

The server cabinet 12 includes a rack 120, a front door 122, and a rear plate 124. The front door 122 and the rear plate 124 are pivotally attached to front and rear sides of the rack 120, respectively, and can be opened or closed relative to the rack 120 as needed.

The rack 120 includes a rectangular top wall 121, a bottom wall 123 parallel to and spaced from the top wall 121, a left sidewall 126 interconnected between left sides of the top and bottom walls 121, 123, and a right sidewall 125 interconnected between right sides of the top and bottom walls 121, 123. The bottom wall 123 defines an opening 127 at a central portion thereof through which cables or other leads can pass to be in electrical connection with the servers 140, exterior power sources (not shown), or other devices. The top wall 121 defines a plurality of ventilating holes 128 therethrough for communicating an interior of the server cabinet 12 with an exterior of the server cabinet 12.

In this embodiment, a supporting frame 129 is formed in the rack 120 of the server cabinet 12 to divide the interior of the server cabinet 12 into two portions; that is, an upper portion over the supporting frame 129, and a lower portion under the supporting frame 129. The supporting frame 129 defines an aperture (not labeled) therein, allowing the upper portion and the lower portion to communicate with each other. Each portion of the interior of the server cabinet 12 receives one server unit 14 and the corresponding heat dissipation device 16 therein. Alternatively, in other embodiments, the rack 120 can have a plurality of supporting frames 129 mounted thereon to divide the interior of the server cabinet 12 into at least three portions to receive more server units 14 therein, according to a height of the rack 120.

In this embodiment, the servers 140 of the server unit 14 are stacked in a horizontal direction along a transverse axis of the rack 120. Each of the server cabinets 12 has a standard rectangular outline. Two flanges 146 respectively extend from front and rear sides of each server 140 to abut a neighboring server 140. The flanges 146 at a front side of the server unit 14 cooperatively form a continuous wall to prevent air from escaping out of the server unit 14 through the front side thereof. The flanges 146 at a rear side of the server unit 14 cooperatively form a continuous wall to prevent air from escaping out of the server unit 14 through the rear side thereof.

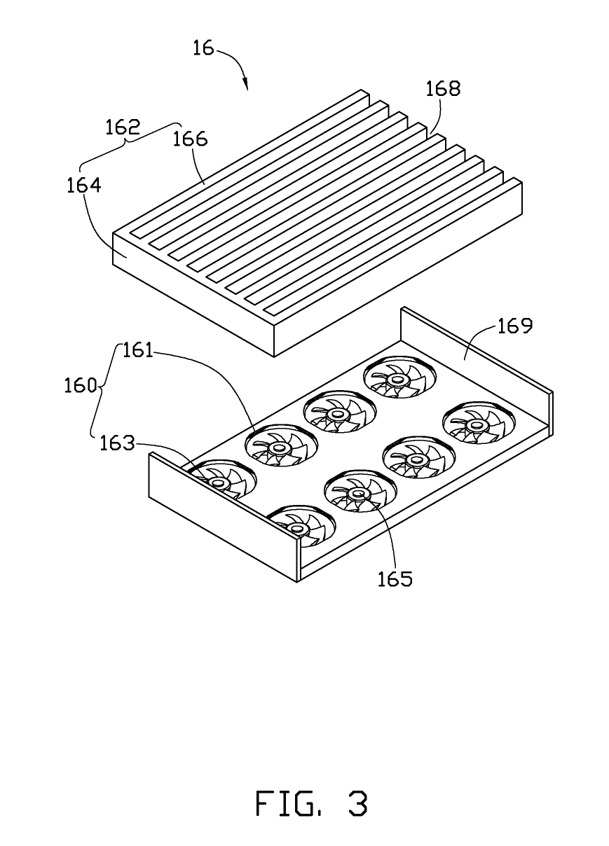

Referring also to FIG. 3, the heat dissipation device 16 is mounted on the server unit 14, and includes a fan module 160 and a dissipating module 162 on the fan module 160.

The fan module 160 includes a rectangular-shaped frame 161, and a plurality of impellers 163 received in the frame 161. In this embodiment, the impellers 163 are configured for drawing air from the servers 140 to the dissipating module 162. A plurality of temperature sensors 165 is respectively connected to circuits of the impellers 163 to control rotation of the impellers 163. Two flanges 169 respectively extend up from front and rear sides of the frame 161, for connecting the fan module 160 to the rack 120.

The dissipating module 162 is arranged on the fan module 160, and located between the flanges 169 of the fan module 160. In this embodiment, the dissipating module 162 is a metal heat sink, and includes a plurality of elongated fins 166 and a transverse end beam 164 interconnecting the fins 166. The fins 166 are parallel to and spaced from each other. Each of the fins 166 extends parallel to a longitudinal axis of the dissipating module 162. An elongated channel 168 is defined between each two neighboring fins 166 through which airflow of the fan module 160 passes.

During typical operation of the server system 10, the servers 140 generate a large amount of heat. The impellers 163 of the fan module 160 rotate to draw cooling air out of the server cabinet 12 into the server cabinet 12 through the opening 127 of the bottom wall 123. The cooling air flows through the servers 140 along an upward axis to exchange heat with the servers 140. The heated air is then drawn through the fan module 160 to the channels 168 by the impeller 163, thereby transferring some of the heat to the fins 166. Finally the fins 166 dissipate the heat to the exterior of the server cabinet 12 through the ventilating holes 128 of the top wall 121. Therefore the heat generated by the servers 140 can be evacuated by the heat dissipation device 16, and accordingly the servers 140 maintain a low working temperature. In addition, since the airflow follows an upward path in the server cabinet 12, the environment around a lateral periphery of the server cabinet 12 is essentially or largely unaffected.

It is to be understood, however, that even though numerous characteristics and advantages of certain embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A server system, comprising:
a server cabinet;
a plurality of servers arranged in the server cabinet; and
a heat dissipation device comprising a fan module mounted on the servers and a dissipating module arranged on the fan module.

2. The server system of claim 1, wherein the fan module comprises a frame and a plurality of impellers rotatably received in the frame.

3. The server system of claim 2, wherein the impellers are configured for drawing airflow along an upward axis in the server cabinet.

4. The server system of claim 2, wherein the fan module further comprises a plurality of temperature sensors respectively connected to circuits of the impellers to control rotation of the impellers.

5. The server system of claim 2, wherein the frame comprises two flanges respectively extending up from two opposite sides thereof to connect the fan module to the server cabinet.

6. The server system of claim 5, wherein the dissipating module is arranged between the flanges of the frame.

7. The server system of claim 6, wherein the dissipating module comprises a plurality of elongated fins arranged between the flanges, and a plurality of channels defined between the fins through which airflow drawn by the impeller passes.

8. The server system of claim 1, wherein the server cabinet comprises a rack, and a front door and a rear plate, both hinged on front and rear sides of the rack, respectively.

9. The server system of claim 8, wherein the rack comprises a rectangular top wall, a bottom wall parallel to and spaced from the top wall, a left sidewall interconnected between left sides of the top and bottom walls, and a right sidewall interconnected between right sides of the top and bottom walls, wherein the servers are arranged between the left and right sidewalls and parallel to the left and right sidewalls, and wherein an opening is defined in the bottom wall, and a plurality of ventilating holes are defined in the top wall.

10. The server system of claim 9, wherein each server comprises two flanges respectively extending from front and rear sides thereof to abut a neighboring server, and the flanges at each of the front and rear sides of the servers cooperatively form a continuous wall to prevent air from escaping out of the servers through the front and rear sides thereof.

11. A server system, comprising:
a server cabinet comprising a rack, a front door and a rear plate, the front door hinged on a front side of the rack;
a plurality of servers arranged in the server cabinet along a transverse axis of the server cabinet; and
a heat dissipation device comprising a fan module mounted on the servers and a dissipating module arranged on the fan module, the fan module configured for drawing airflow in a direction from the plurality of servers upward to a top of the server cabinet.

12. The server system of claim 11, wherein the fan module comprises a frame, a plurality of impellers rotatably received in the frame, and a plurality of temperature sensors respectively coupled to circuits of the impellers to control rotation of the impellers.

13. The server system of claim 12, wherein the frame comprises two flanges respectively extending up from two opposite sides thereof to connect the fan module to the rack of the server cabinet.

14. The server system of claim 13, wherein the dissipating module comprises a plurality of elongated fins arranged between the flanges, and a plurality of channels are defined between the fins through which airflow is drawn by the impeller.

15. The server system of claim 11, wherein each server comprises two flanges respectively extending from front and rear sides thereof to abut a neighboring server, and wherein the flanges at each of the front and rear sides of the servers cooperatively form a continuous wall to prevent air from escaping out of the servers through the front and rear sides thereof.

16. The server system of claim 11, wherein the rack comprises a rectangular top wall, a bottom wall parallel to and spaced from the top wall, a left sidewall interconnected between left sides of the top and bottom walls, and a right sidewall interconnected between right sides of the top and bottom walls, an opening being defined in the bottom wall, and a plurality of ventilating holes being defined in the top wall.

17. A heat dissipation device, comprising:
a fan module configured for mounting over a plurality of heat-generating components and drawing up heated air from around the heat-generating components; and
a dissipating module mounted on the fan module, the heat dissipating module defining a plurality of channels through which the heated air drawn by the fan module can pass to locations above the dissipating module.

18. The heat dissipation device of claim 17, wherein the fan module comprises a frame, a plurality of impellers rotatably received in the frame, and a plurality of temperature sensors respectively coupled to circuits of the impellers to control rotation of the impellers.

19. The heat dissipation device of claim 18, wherein the frame comprises two flanges respectively extending up from two opposite sides thereof for connecting the fan module.

20. The heat dissipation device of claim 19, wherein the dissipating module comprises a plurality of elongated metal fins arranged between the flanges, between which the channels are defined.
